(19) United States
(12) Patent Application Publication
(10) Pub. No.: US 2021/0086342 A1
(43) Pub. Date: Mar. 25, 2021

(54) HANDLE EXTENSION TO ASSIST PERSONS OR INDIVIDUALS

(71) Applicant: Joan Cohen, Maple Glen, PA (US)

(72) Inventor: Joan Cohen, Maple Glen, PA (US)

(21) Appl. No.: 16/579,491

(22) Filed: Sep. 23, 2019

(51) Int. Cl. B25G 1/04; A47L 9/32; B25G 3/00

(52) U.S. Cl. CPC B25G 1/04; B25G 3/00; A47L 9/325; A47L 9/322

(57) ABSTRACT

An adapter comprising a handle assembly and connector is disclosed that can be securely attached to single handle household device, such as a vacuum cleaner. The adapter once attached assists individuals with the operation of the household device.

### FIELD OF THE EMBODIMENTS

This invention pertains to a handle extension device or handle adaptation that assists individuals with the operation of a household device such as a vacuum cleaner.

### BACKGROUND OF THE EMBODIMENTS

Physically challenged persons including disabled individuals or the elderly suffering from arthritis, or even non physically challenged persons such as the general population, often have great difficulty operating household cleaning equipment especially those devices having only a single handle. Specialized equipment or cleaning services can be prohibitively expensive for retirees on a fixed income. This problem is becoming more prevalent as the U.S. population ages. Hence, there is an ongoing and growing need for accessories and/or accommodations that facilitate the operation of cleaning devices by physically challenged persons or for ease of use by the general population.

Examples of related art are described below:

U.S. Pat. No. 4,635,315 discloses an upright converter for a portable hand-held vacuum having nozzle and handle portions. The upright converter includes an adapter cooperating with the nozzle portion of the vacuum in a position for operation thereof and an adapter cooperating with the handle portion of the vacuum at a location remote from the nozzle adapter where the nozzle adapter and the handle adapter are interconnected such that the vacuum is retained therebetween. In addition, the upright converter includes a handle extending to a position to be gripped by a user in upright vacuum fashion.

U.S. Pat. No. 5,290,055 discloses a push bar apparatus for use with a collapsible wheelchair adapted for quick disconnect and engagement with a plurality of sizes hand grips of wheelchairs to permit one handed pushing of the wheelchair by an attendant, leaving the other hand free. The push bar has an elongated bar with hollow sleeve adapters at opposite ends, having positive locking devices adapted to engageably receive the pair of grip handles in spatial relationship extending rearwardly in a horizontal plane from the back of a collapsible wheelchair. The push bar device eliminates the need to twist a user's wrists thereby making pushing the heavy weight of patient in wheelchair much easier; a particular advantage to an elderly attendant.

U.S. Pat. No. 8,690,333 discloses an adapter for a steering handle of a camera dolly includes a first part and a second part attached to the first part in a way that allows for angular adjustment between them. This allows the steering handle to be aligned or squared up relative to the dolly chassis. The first part may be an adapter base and the second part may be a riser. The adapter base may have a flange with slotted holes alignable with holes in the riser. When installed on a camera dolly, the adapter allows the steering handle to align as desired. The adapter also raises the steering handle up, to allow for ergonomic use by a taller dolly operator.

U.S. Pat. No. 9,132,312 discloses a handle adaptor is provided for a weight training device. The handle adaptor includes a handle extending from a neck having a first end and a second end. A slot is defined in the neck. The slot has an opening adapted to receive a bar of the weight training device. The slot further includes a seat for supporting the bar of the weight training device. A biasing member may also be provided to bias the bar against the seat of the slot.

The published European Patent Application No. EP2837318A1 teaches a handle adapter (2) for a suction tube (4) of a vacuum cleaner (1). The handle adapter (2) has a sleeve (12) and a handle (7). The sleeve (12) comprises a cutout (8) having a length of at least 1 cm.

The published Japanese Patent No. JP4360927B2 discloses a socket wrench with a grip handle.

None of the art described above art addresses all the issues that the present disclosure does. For example, none of the art teaches a handle extension or handle adaptation that facilitates the operation of single hand household devices by physically challenged individuals or for ease of use by the general population.

### SUMMARY OF THE EMBODIMENTS

In a first aspect, an adapter for assisting a person with the operation of a cleaning device is disclosed that comprises a connector reversibly attached to a cleaning device, and a handle assembly attached to the connector, wherein the handle assembly is configured to be held by both hands of a physically challenged person or for ease of use by the general population.

In a second aspect, an adapter for assisting a person with the operation of a cleaning device is disclosed that consists of a connector reversibly attached to a cleaning device, and a handle assembly attached to the connector, wherein the handle assembly is configured to be held by both hands of a physically challenged person or for ease of use by the general population.

In certain embodiments of the first or second aspect, the device has a single handle that is integral and unitary.

In certain embodiments of the first or second aspect, the device is floor cleaning equipment, such as a vacuum cleaner.

In certain embodiments of the first or second aspect, the connector is reversibly attached to the handle or arm of the cleaning device.

In certain embodiments of the first or second aspect, the handle assembly comprises two handles, each handle being configured to be held by one of hands of a physically challenged person or for ease of use by the general population. In certain embodiments, each handle can have a grip.

In certain embodiments of the first aspect, the adapter further comprises an extender element having a proximal and distal end, wherein the distal end of the extender element is secured to the connector element and the proximal end of the extender element is attached to the handle assembly.

In certain embodiments, the extender element can increase the distance between the cleaning device and the adapter's handle assembly.

In a third aspect, an adapter for assisting a person with the operation of a cleaning device is disclosed that comprises a connector comprising a substantially circular opening through which a handle of the cleaning device can be inserted and reversibly secured to the connector, and a handle assembly attached to the connector, wherein the connector and the handle assembly are substantially within the same plane, and wherein the handle assembly is configured to be held by a physically challenged person using both hands or for ease of use by the general population.

In certain embodiments of the third aspect, the cleaning device has a single handle that is integral and unitary.

In certain embodiments of the third aspect, the handle assembly comprises two handles opposite each other, each handle being configured to be held by one of hands of the physically challenged person or for ease of use by the general population. Each handle can comprise a grip.

In certain embodiments of the first, second or third aspect, the cleaning device is a floor cleaning device such as a bag or bagless vacuum, a mop, a broom, a canister-type cleaner, an accessory tool, or a hand-held portable cleaner.

In certain embodiments, the cleaning device is manufactured and equipped with an integral handle for a person to hold on to with one hand and/or an integral handle for a person to hold on to with two hands. These integral handles will be located either above or below the other handle and/or can be adjusted in height.

In a fourth aspect, a method for assisting a person with the operation of a cleaning device is disclosed that comprises attaching the adaptor of any one of the first, second or third aspect to a handle or arm of a cleaning device, holding the adaptor with both hands, and pushing and pulling the cleaning device to clean the floor. In certain embodiments, the cleaning device is a single handle device. In certain embodiments, the single handle device is a floor cleaning device such as a bag or bagless vacuum, a mop, a broom, a canister-type cleaner, or a hand-held portable cleaner.

### BRIEF DESCRIPTION OF THE DRAWINGS

FIG. 1 shows an exemplary depiction of the handle extension adapter attached to a single handle vacuum cleaner.

FIG. 2 shows an exemplary mechanism for the attachment of a handle extension to a vacuum cleaner.

FIG. 3 shows an exemplary depiction of an embodiment of the adapter.

### DESCRIPTION OF THE PREFERRED EMBODIMENTS

Unless defined otherwise, all technical and scientific terms used herein have the same meanings as commonly understood by one of skill in the art to which the disclosure herein belongs.

As used herein, the singular forms “a,” “an,” and “the,” are intended to include the plural forms as well, unless the context clearly indicates otherwise.

The phrase “and/or,” as used herein in the specification and in the claims, should be understood to mean “either or both” of the elements so conjoined, i.e., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

As used herein, a “physically challenged person” refers to a person who has difficulty operating, e.g. pushing or pulling, a household device having a single handle, such as a vacuum cleaner.

As used herein, a person can be “physically challenged” if he or she is, for example, elderly, injured, handicapped and/or disabled.

As used herein, a “household device” can refer to any piece of equipment or cleaning devices commonly used in a home that is heavy or bulky or otherwise difficult to operate by a physically impaired person or the general population.

In certain embodiments, the piece of equipment has only one handle.

In certain embodiments, a device, such as a vacuum cleaner, creates suction to aspirate dirt or debris for a dry surface.

In certain embodiments, the surface can be a surface of a rug.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

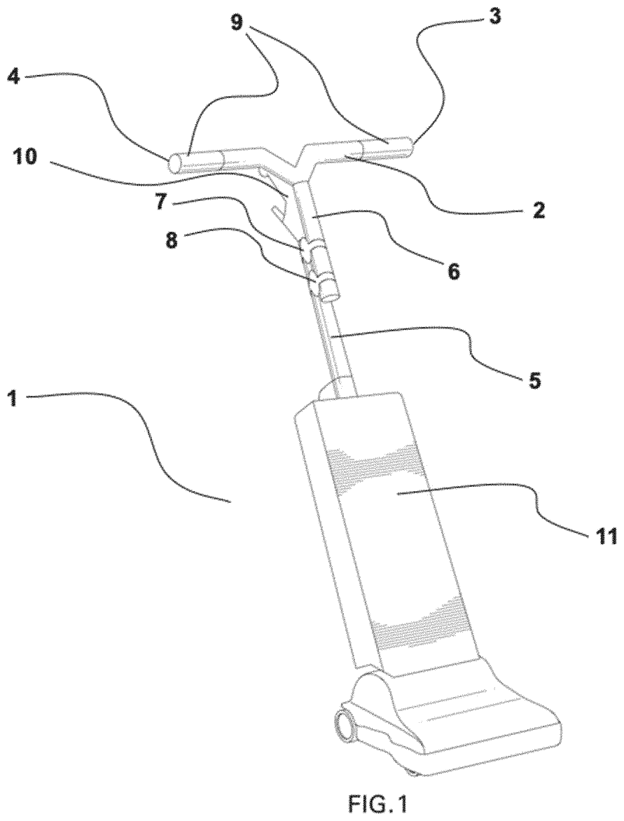

FIG. 1 shows an exemplary handle assembly 2 adapter attached to a vacuum cleaner 1 with a single handle 10. The handle assembly 2 comprises a handle for the operator's left hand or 3 and a handle for the operator's right hand 4. Each of the handles 3 and 4 can have a grip 9. Both handles 3 and 4 are connected to a connector 6 which is itself attached to the arm 5 between the single handle 10 and the body of the vacuum cleaner 11 by two grip brackets 7 and 8.

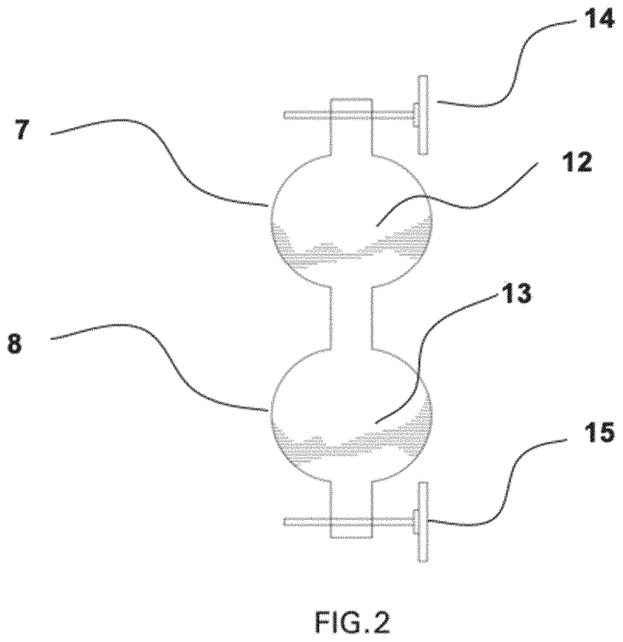

FIG. 2 shows an exemplary depiction of the grip bracket 7 and aperture 12 through which the arm 5 of the vacuum cleaner 1 can be secured by the tightening of the wingnut 14 and the grip bracket 8 and aperture 13 through which the connector 6 is secured by tightening the wingnut 15.

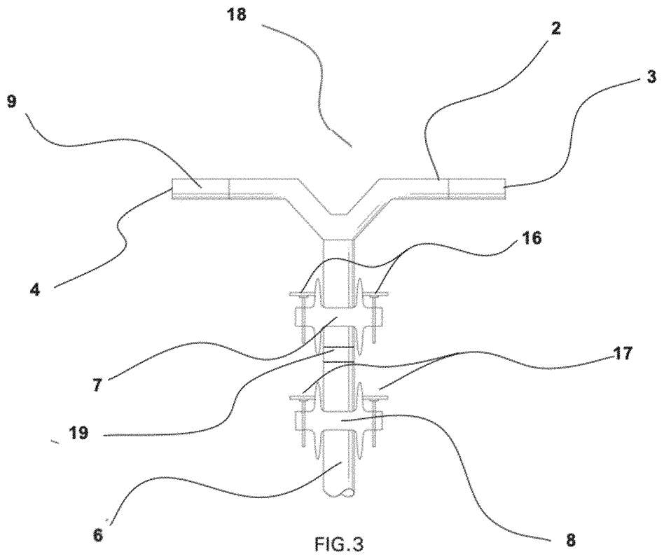

FIG. 3 shows an exemplary depiction of an adapter 18 comprising a handle assembly 2 having a handle for the operator's left hand 3 and a handle for the operator's right hand 4. Each of the handles 3 and 4 can have a grip 9. Both handles 3 and 4 are connected to a connector 6 having an extender element 19 that can extend the length of the connector 6 as needed. FIG. 3 also shows grip brackets 7 and 8 each having two wingnuts 16 and 17 respectively. Grip brackets 7 and 8 enable the attachment of the connector 6 to the arm 5 of the vacuum cleaner 1 by tightening wingnuts 16 and 17.

In certain embodiments, the grip brackets 7 and 8 can be replaced with any grip mechanism allowing the connector 6 to be securely attached to the arm 5 of the vacuum cleaner 1. In certain embodiments, the grip brackets and the handle are not two separate components but are one unitary piece that attaches to a household device.

In another embodiment, the actual device, such as a cleaning device can be made with an integral handle for a person to hold on to with one hand and/or an integral handle wherein the handle comprises a handle with two ends for a person to hold on to with two hands.

What is claimed is:

1. An adapter for assisting a person with the operation of equipment, comprising;
a connector reversibly attached to a device, and
a handle assembly attached to the connector,
wherein the handle assembly is configured to be held by both hands of the person.

2. The adapter of claim 1, wherein the device has a single handle.

3. The adapter of claim 1, wherein the device is floor cleaning equipment.

4. The adapter of claim 1, wherein the device is a vacuum cleaner.

5. The adapter of claim 1, wherein the connector is reversibly attached to the handle of the device.

6. The adapter of any one of claim 1, wherein the handle assembly comprises two handles, each handle being configured to be held by one of the hands of the person.

7. The adapter of claim 6, wherein each handle comprises a grip.

8. The adapter of claim 1, further comprising an extender element having a proximal and distal end, wherein the distal end of the extender element is secured to the connector element and the proximal end of the extender element is attached to the handle assembly.

9. The adapter of claim 8, wherein the extender element can increase the distance between the device and the adapter's handle assembly.

10. An adapter for assisting a person with the operation of a cleaning device comprising:
a connector comprising a substantially circular opening through which a handle of the cleaning device can be inserted and reversibly secured to the connector, and
a handle assembly attached to the connector,
wherein the connector and the handle assembly are substantially within the same plane, and wherein the handle assembly is configured to be held by the person using both hands.

11. The adapter of claim 10, wherein the cleaning device has a single handle.

12. The adapter of claim 10, wherein the handle assembly comprises two handles opposite each other, each handle being configured to be held by one of a persons hands.

13. The adapter of claim 12, wherein each handle comprises a grip.

14. The adapter of claim 10, wherein the cleaning device is a floor cleaning device.

15. The adapter of claim 14, wherein the floor cleaning device comprises a bag or bagless vacuum, a mop, a broom, a canister-type cleaner, or a hand-held portable cleaner.

16. A method for assisting a person with the operation of a household device, comprising
attaching the adaptor of any one of claims 1, 2 and 11 to a handle of a household device,
holding the handle assembly with both hands and operating the device by pushing and pulling the handle assembly.

17. The method of claim 16, wherein the household device is a single handle device.

18. The method of claim 16, wherein the single handle device is a floor cleaning device.

19. The method of claim 18, wherein the floor cleaning device comprises a bag or bagless vacuum, a mop, a broom, a canister-type cleaner, or a hand-held portable cleaner.

20. The method of claim 16, wherein the household device is configured to include both a handle for use by one hand of the person and/or a handle for use by two hands of the person.
